(19) United States
(12) Patent Application Publication
(10) Pub. No.: US 2021/0326699 A1
(43) Pub. Date: Oct. 21, 2021

(54) TRAVEL SPEED PREDICTION

(71) Applicant: INRIX, Inc., Kirkland, WA (US)

(72) Inventors: Andrew Davies, Manchester (GB); Dominic Jason Jordan, Manchester (GB)

(21) Appl. No.: 17/158,108

(22) Filed: Jan. 26, 2021

Related U.S. Application Data
(60) Provisional application No. 63/012,938, filed on Apr. 21, 2020.

(51) Int. Cl. G06N 3/08; G06N 3/04

(52) U.S. Cl. CPC G06N 3/08; G06N 3/04

(57) ABSTRACT

One or more techniques and/or systems are provided for travel speed prediction. A spatial context of a prediction segment of a travel network for which a speed prediction is to be made is identified. The spatial context comprises one or more segments of the travel network that are part of trajectories of objects passing through the predication segment and that have predicted likelihoods of influencing travel speed along the prediction segment above a threshold. Features of the spatial context are formatted into a format compatible for input into the model based upon a structure of the model. The features are input into the model for processing using machine learning functionality to output the speed prediction for the prediction segment.

### RELATED APPLICATIONS

This application claims priority to U.S. Provisional Patent Application, titled “TRAVEL SPEED PREDICTION”, filed on Apr. 21, 2020 and accorded Application No.: 63/012,938, which is incorporated herein by reference.

### BACKGROUND

Many navigation services, applications, and devices are capable of generating and providing users with routes from starting locations to destination locations. These services, applications, and devices are also capable of providing estimated times of arrival to the destination locations. For example, a user may request directions from a grocery store to a coffee shop through a navigation application executing on a mobile device, such as smart phone of the user. The navigation application may generate and display one or more routes for the user to select. The routes may be generated and suggested as fastest routes, shortest routes, etc. In response to the user selecting a route, the route may be displayed on a map interface within the navigation application, along with an estimated time of arrival that may be updated in real-time.

The navigation application may be managed by a navigation service, which may be hosted on a computing device remote to the mobile device of the user. The navigation service sends data to the navigation application, such as suggested routes and estimated times of arrival. The navigation service may utilize locational information (e.g., global positioning system (GPS) data) received from devices (e.g., the mobile device, a vehicle, etc.) in order to generate the routes and/or to determine the estimated times of arrival. The navigation service may utilize heuristics and the locational information to estimate travel speeds along segments of roads from the grocery store to the coffee shop in order to identify routes with relatively shorter travel times and/or to determine a current estimated time of arrival.

Unfortunately, the navigation service may be unable to accurately determine actual travel speeds along the segments, and thus may provide inaccurate estimated times of arrival and/or less efficient routes, such as where the navigation service suggests a route as being a fastest route that is in fact actually a slower route than others. In particular, noise within the locational information and/or natural variable speeds (e.g., speeds near a traffic light that vary based upon whether the traffic light is red or green) can cause large fluctuations in predicted speeds. Also, sudden traffic changes (e.g., a sudden onset of congestion) will not be identified by the navigation service right away, thus causing latency until the predicted speeds finally reflect the sudden traffic changes. Furthermore, if there is a sparse amount of data points (low density data) within the locational information for a segment, then the navigation service may revert to historical average speeds computed under normal conditions, which can lead to large errors.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for travel speed prediction are provided. A travel network may comprise a road network of roads (e.g., city roads, highway roads, interstate roads, etc.), a sidewalk network of pedestrian sidewalks, or other networks of travel (e.g., running trails, a network of streams and waterways, etc.). As objects (e.g., a truck, a car, a mobile device, a bike, a scooter, a device carried by a pedestrian, a delivery vehicle, etc.) travel along the travel network, locational information such as GPS data may be obtained from the objects. A map matching algorithm may be performed to map the locational information to portions of the travel network. Other data may also be obtained and mapped to the portions of the travel network, such as weather data, incident data (e.g., a traffic accident), imagery from a camera of a vehicle, vehicle operation data (e.g., whether a brake was applied, whether a windshield wiper is on or off, etc.), event data (e.g., a concert that could affect the flow of traffic), sensor data (e.g., light detect and ranging (LIDAR) data), etc. This data may be used by one or more models to output speed predictions for a prediction segment of the travel network. The speed predictions may be used to determine routes and/or estimated times of arrival for travel within the travel network.

The travel network may be segmented into segments, such as the prediction segment for which a speed prediction is to be made. A segment may be defined as a portion of the travel network that does not cross a junction (e.g., does not cross through a traffic intersection). A segment may be limited to a maximum length, such as 100 meters or any other length. The segments within the travel network may be defined such that the segments have a relatively uniform length distribution.

The segments of the travel network may be evaluated to identify a spatial context of the prediction segment for which the speed prediction is to be made. The spatial context may comprises one or more segments that are likely to influence travel speed along the prediction segment. In particular, the locational information, mapped to the travel network, is used to identify trajectories of objects (e.g., a driving route traveled by a vehicle, a walking route traveled by a mobile device held by a pedestrian, etc.) within the travel network. Trajectories that include the prediction segment may be identified. Segments of those trajectories that pass through the prediction segment, and which have a predicted likelihood of influencing travel speed along the prediction segment above a threshold are identified as the spatial context of the prediction segment. For example, segments within a threshold proximity to the prediction segment that are traveled just before or after the prediction segment may have a higher predicted likelihood of influencing travel speed along the prediction segment than other segments that are further away from the prediction segment.

A model or multiple models (e.g., a convolutional neural network, a graph convolutional neural network, etc.) may be selected for outputting the speed prediction for the prediction segment based upon various selection criteria. Features of the segments within the spatial context may be identified and/or formatted into a format compatible for input into the model based upon a structure of the model (e.g., one-dimensional convolutional features, two-dimensional convolutional features, a fixed graph structure of features, an arbitrary graph structure of features, an image structure of features, etc.). The features may comprise an average speed of objects along a segment, a historic average speed for the segment, weather conditions, incident information, data within a traffic trace image, vehicle operation data, imagery, sensor data, event data, and/or other data. The features may correspond to ground truth data used to train the model. That is, given ground truth data (e.g., a speed data point of a segment at a particular time), a set of corresponding features are created. In an example, outlier data may be identified and removed from the ground truth data.

The features, together with the ground truth data (e.g., speed data points of certain segments at particular times), are input into the model. Machine learning functionality of the model processes the features and the ground truth data in order to output a speed prediction for the prediction segment. The speed prediction may be a near-future speed prediction (e.g., a real-time speed prediction of traffic flow along the prediction segment) or a future speed prediction (e.g., a speed prediction of traffic flow along the prediction segment in 20 minutes from a current time or any other future time). Travel data, such as a route from a starting location to a destination location and/or an estimated time of arrival may be generated and displayed on a device (e.g., a mobile device, a vehicle navigation unit, etc.) based upon the speed prediction for the prediction segment.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of travel speed prediction.

FIG. 2A is a component block diagram illustrating an exemplary system for travel speed prediction, where segmentation is performed.

FIG. 2B is a component block diagram illustrating an exemplary system for travel speed prediction, where a spatial context is determined for a prediction segment.

FIG. 2C is a component block diagram illustrating an exemplary system for travel speed prediction, where a speed prediction is generated.

FIG. 3 is a component block diagram illustrating an exemplary system for travel speed prediction, where a route is generated and displayed on a client device based upon speed prediction data.

FIG. 4 is a component block diagram illustrating an exemplary system for travel speed prediction, where an estimated time of arrival is generated and displayed on a client device based upon speed prediction data.

FIG. 5 is an illustration of an exemplary computing device-readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

One or more computing devices and/or techniques for travel speed prediction are provided. Many applications and services are configured to generate and/or display routes from starting locations to destination locations on computing devices of users, such on a mobile device, a smart phone, a smart watch, a vehicle navigation unit, etc. These applications and services may also be configured to provide real-time estimated times of arrival to the destination locations. The routes, the estimated times of arrival, and/or other functionality provided by the applications and services may utilize speed predictions along segments of roads of a travel network to determine what routes to suggest to users and to calculate current estimated times of arrival.

The speed predictions may be generated based upon locational information, such as global positioning system (GPS) data, acquired from devices traveling within the travel network. For example, a GPS device within a vehicle may transmit GPS data over a cellular network to a navigation service hosted by one or more computers. The navigation service may process the GPS data in order to map the GPS data to segments (e.g., roads, sidewalks, etc.) within the travel network. The navigation service may process the GPS data using heuristics in order to determine the speed of the vehicle while traveling along each segment of the travel network. The navigation service may collect locational data from a plurality of vehicles traveling within the travel network in order to predict speeds at which the vehicles travel along segments of the travel network. These predicted speeds can be used by the navigation service to identify fastest routes from starting locations to destination locations and/or to calculate real-time estimated times of arrival to the destination locations based upon predicted traffic speeds along segments included within the routes. These routes and estimated times of arrival may be transmitted from the navigation service to client devices over a network for display on the devices to users, such as through a smart phone or vehicle navigation unit.

Unfortunately, the speed predictions by the navigation service utilizing the heuristics may be inaccurate, thus leading to inaccurate route suggestions and estimated times of arrival. This inaccuracy can be caused by noise in the locational information, and also due to natural variable speeds (e.g., vehicle speeds through an intersection with a traffic light will vary depending on whether the traffic light is green or red), which can cause large fluctuations in predicted speeds. Sudden traffic changes, such as a sudden onset of congestion that greatly reduces traffic flow speeds, can cause latency between when the traffic flow speeds changed and when predicted speeds will finally reflect the reduced traffic flow speeds. Furthermore, if there is a lack of data (e.g., low density locational information and/or no information about incidents along a segment), then the navigation service may revert to historical average speeds computed under normal conditions for speed prediction, which can result in large errors in predicting speeds because weather, accidents, current conditions, and/or other conditions are not taken into account.

Accordingly, as provided herein, machine learning is utilized to predict speeds (e.g., near-future traffic speeds or future traffic speeds) along segments within a travel network. In particular, a model will utilize machine learning functionality (e.g., a convolutional neural network, a graph convolutional neural network, or any other type of machine learning model/functionality) to take into account the structure of the travel network so that not just a prediction segment for which a speed prediction is to be generated is taken into account, but also other segments within the travel network are taken into account. Data prepossessing is performed upon features to ensure that the model is trained on reliable data. The preprocessing may utilize vehicle trajectories to identify certain features to use with the ground truth data, such as by including features of segments that are part of vehicle trajectories passing through the prediction segment, and thus having likelihoods of affect travel speeds along the prediction segment. The preprocessing may also remove outlier data from the ground truth data. In this way, the features and ground truth data is used to train the model to output more accurate speed predictions for the prediction segment. Thus, speed predictions for segments within the travel network are more accurate and are less susceptible to noise. Accordingly, more accurate route suggestions (e.g., suggestion of a fastest route that is in fact the fastest route) and estimated times of arrival can be generated and displayed on devices to users.

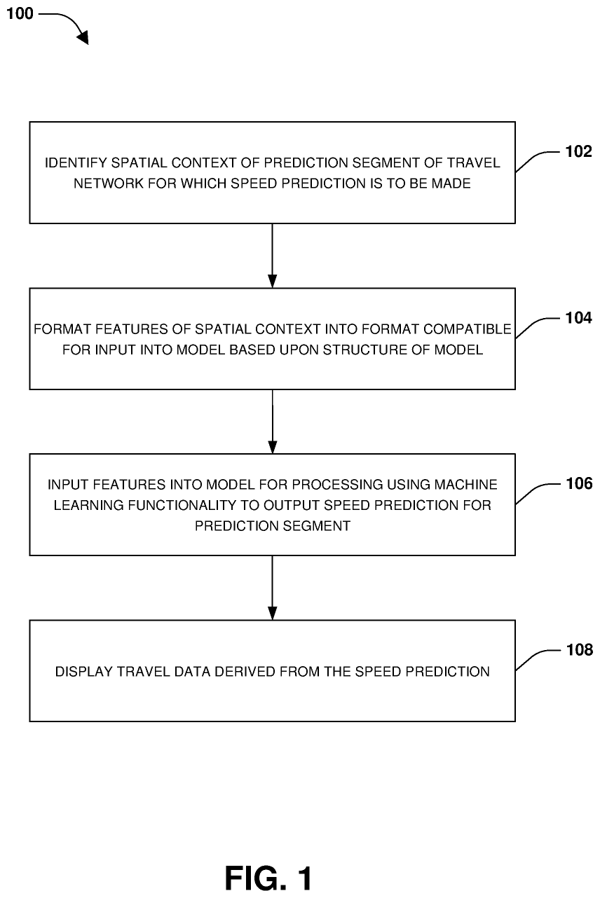

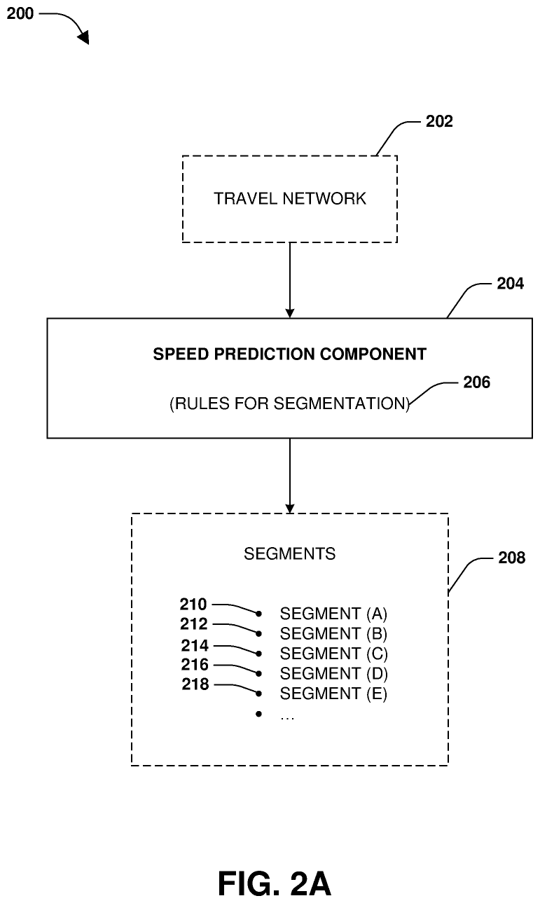

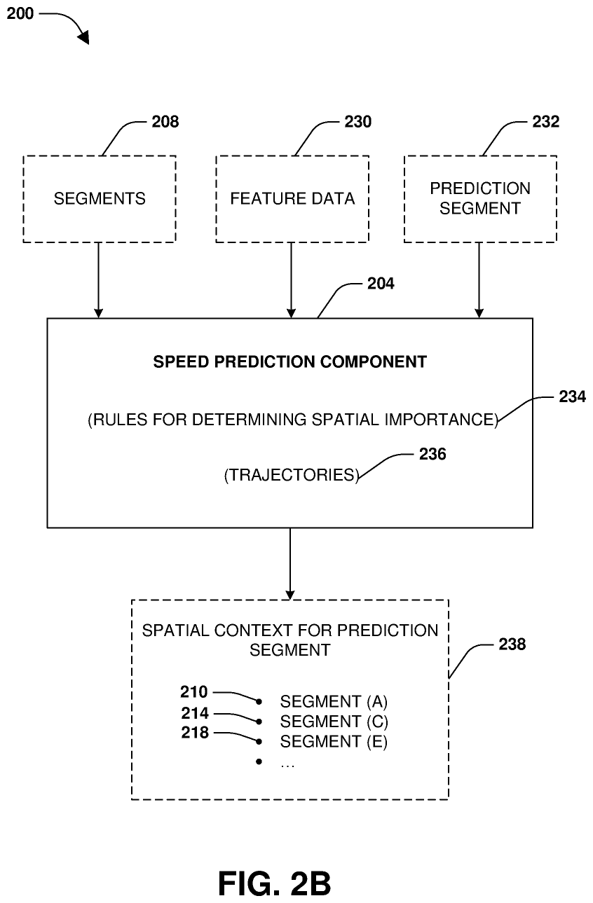

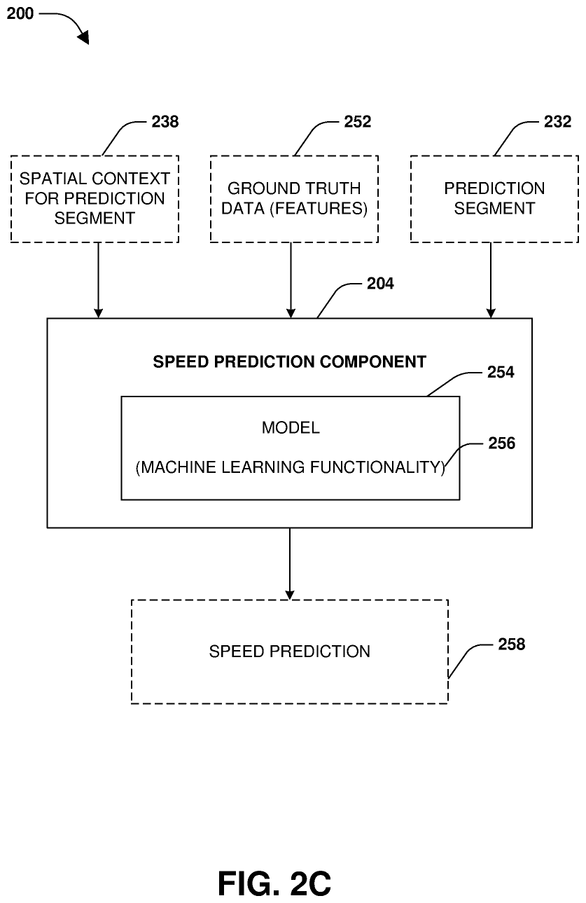

An embodiment of travel speed prediction is illustrated by an exemplary method 100 of FIG. 1, and is described in conjunction with system 200 of FIG. 2A-2C. A speed prediction component 204 may be hosted by a computer, a mobile device, a server, a virtual machine, a service executing within a cloud computing environment, a vehicle computer, hardware, software, or combination thereof. In an example, the speed prediction component 204 is hosted by a service executing on a server with network communication capabilities for receiving data from and transmitting data to vehicles, computing devices, mobile devices, watches, and/or other types of devices (objects). For example, the speed prediction component 204 may receive locational information (e.g., GPS data), sensor data (e.g., light detection and ranging (LIDAR) data from a vehicle), vehicle operation data (e.g., whether a turn signal of a vehicle is on or off, a current setting of a windshield wiper of the vehicle, a remaining amount of gas within the vehicle, etc.), imagery (e.g., an image or video captured by a camera associated with the vehicle), and/or other types of data from the devices over a network by using the network communication capabilities of the server. The speed prediction component 204 may utilize the network communication capabilities of the server to transmit routes, estimated times of arrival, and/or other information over the network to devices for display to users.

The speed prediction component 204 may identify a prediction segment 232 for which a speed prediction is to be made. For example, a navigation application executing on a device (e.g., a vehicle computer or mobile device) may transmit a request to the speed prediction component 204 over the network for one or more suggested routes from a starting location to a destination location or a request for a current estimated time of arrival to the destination location. Determining what routes to suggest (e.g., a fastest route) and/or the current estimated time of arrival may be made based upon speed predictions for the prediction segment 232 and/or other segments along the routes to the destination location. The prediction segment 232 may be part of a travel network 202 of segments 208 (e.g., roads, sidewalks, etc.). In an example, the speed prediction component 204 performs segmentation upon the travel network 202 in order to identify the segments 208 and the prediction segment 232 within the travel network 202, as illustrated by FIG. 2A.

The speed prediction component 204 may utilize various rules 206 for segmenting the travel network 202 into the segments 208. In an embodiment, the speed prediction component 204 may implement a first rule that a segment is to be defined as a portion of the travel network (e.g., a portion of a road, trail, sidewalk, land, etc.) that does not cross a junction (e.g., a traffic intersection). In an embodiment, the speed prediction component 204 may implement a second rule that a length of a segment cannot exceed a maximum length, such as 100 meters, 50 meters, 120 meters, or any other length. In an embodiment, the speed prediction component 204 may implement a third rule that a distribution of segment lengths is to be within a threshold uniformity while still satisfying the first rule and/or the second rule (e.g., the distribution of segment lengths should not vary more than a certain length, such as 10 meters or any other threshold uniformity of length). In this way, the speed prediction component 204 segments the travel network 202 into the segments 208, such as a segment (A) 210, a segment (B) 212, a segment (C) 214, a segment (D) 216, a segment (E) 218, the prediction segment 232, and/or other segments.

At 102, the speed prediction component 204 may identify a spatial context 238 for the prediction segment 232 based upon the segments 208, feature data 230, rules 234 for determining spatial importance, and/or trajectories 236 of objects traveling along the segments 208, as illustrated by FIG. 2B. For example, the speed prediction component 204 may collect the feature data 230 from various data sources (e.g., a mobile device, a weather service, an event website, a traffic service, etc.) and objects (e.g., a vehicle, a mobile device, etc.). For example, the feature data 230 may comprise locational information such as GPS data collected from objects, such as vehicles, mobile devices (e.g., a smart phone, a watch, or a wearable device with a GPS unit), scooters, bikes, trucks, etc. The speed prediction component 204 may process the locational information from the objects in order to identify the trajectories 236 of the objects. A trajectory of an object may correspond to a series of segments within the travel network 202 traversed by the object during a travel session (e.g., a route of segments traveled by a scooter while traveling from a coffee shop to a shopping mall). The trajectory may comprise an ordered list of the segments within the travel network 202 through which the object traversed during the travel session, such that the segments are listed in an order of which the segments were traveled during the travel session by the object. In this way, the trajectories 236 of objects, such as vehicles and mobile devices, within the travel network 202 are identified by the speed prediction component 204.

The speed prediction component 204 may evaluate the trajectories 236 using the rules 234 to identify a set of trajectories that include the prediction segment 232. The set of trajectories correspond to trajectories of objects that traveled through the prediction segment 232 (e.g., the trajectory of the scooter may be included within the set of trajectories based upon the scooter traversing the prediction segment 232 during the travel session from the coffee shop to the shopping mall). Trajectories that do not include the prediction segment 232 are not included within the set of trajectories, in some examples.

The rules 234 may indicate that segments within the set of trajectories may be candidate segments for inclusion within the spatial context 238 for the prediction segment 232 because the segments are part of trajectories of objects that passed through the prediction segment 232 while traveling along the trajectories. Because some of the trajectories within the set of trajectories may be relatively long (e.g., a truck may have traveled 100 miles during a single travel session along a trajectory), some of the candidate segments may not influence travel speeds along the prediction segment 232 (e.g., a segment that was traveled 90 miles before reaching the prediction segment 232 by the truck may have little to no influence on travel speeds along the prediction segment 232).

Accordingly, the speed prediction component 204 may utilize the rules 234 to identify candidate segments having predicted likelihoods of influencing travel speeds along the prediction segment 232 greater than a threshold. For example, the rules 234 may indicate that segments closer to the prediction segment 232 and/or segments that are routinely traveled just before and just after the prediction segment 232 may influence travel speeds along the prediction segment 232 more than other segments that are further away or segments that are rarely traveled just before or after the prediction segment 232. For example, an accident in a segment that is traveled just after the prediction segment 232 is more likely to cause congestion and slower travel speeds within the prediction segment 232 than an accident in a segment that is 30 miles before the prediction segment 232. In this way, the candidate segments having predicted likelihoods of influencing travel speeds along the prediction segment 232 greater than the threshold are included within the spatial context 238. For example, the spatial context 238 may comprise the segment (A) 210, the segment (C) 214, the segment (E) 218, and/or other segments.

The feature data 230 may comprise other types of data than locational information, which may be preprocessed (e.g., outlier removal, filtering of certain features, inclusion of other select features, formatting of features into a format corresponding to a structure of a model 254, etc.) and used with ground truth data 252 (e.g., speed of a segment at a particular time) for training the model 254 for outputting speed predictions, as illustrated in FIG. 2C. In an example, the feature data 230 may comprise weather condition data in an area surrounding the prediction segment 232 and/or the segments within the spatial context 238 for the prediction segment 232. The feature data 230 may comprise the weather condition data because weather conditions (e.g., heavy rain, snow and ice, etc.) can affect travel speeds along the prediction segment 232. In an example, speed prediction component 204 may obtain the weather condition data from a weather service, a weather website, etc. In another example, the speed prediction component 204 may identify the weather condition data based upon imagery from vehicles (e.g., an image depicting heavy rain) and/or vehicle operation data from the vehicles (e.g., a vehicle may report that windshield wipers are on a high setting). In an example, the feature data 230 may comprise incident information of incidents that are predicted to affect travel speed along the prediction segment 232. The incident information may comprise traffic accidents, construction, or other incidents. The speed prediction component 204 may obtain the incident information from a traffic service or other data source.

In an example, the feature data 230 may comprise event data of events having a predicted likelihood of influencing travel speed along the prediction segment 232 above a threshold. The event data may pertain to a sporting event, a festival, a concert, a protest, a parade, and/or a wide variety of events that could result in increased congestion for the prediction segment 232 and/or segments within the spatial context 238 of the prediction segment 232, and thus slower travel speeds along the prediction segment 232.

In an example, the feature data 230 comprises vehicle operation data from vehicles. The vehicle operation data may correspond to various operational aspects of a vehicle, such as whether a blinker is on or off, a setting of a windshield wiper, vehicle exhaust and emission data, a current gear being engaged by the vehicle, whether the radio is on or off, gas consumption data, whether a window is up or down, whether autonomous driving functionality is engaged or not, and/or a wide variety of other operational aspects of the vehicle. The vehicle operation data may be used to determine a validity/accuracy of other information, such as weather information (e.g., if a vehicle's windshield wipers are off and windows are down, then weather information indicative of heavy rain may be determined to have a low accuracy). The vehicles may collect, store, and transmit the vehicle operation data from the vehicles to the speed prediction component 204 over a network.

In an example, the feature data 230 comprises imagery captured by cameras associated with vehicles. A camera of a vehicle may capture images and/or videos as the imagery. The vehicle may capture, store, and transmit the imagery from the vehicle to the speed prediction component 204 over the network. The imagery may be indicative of road conditions, incidents, weather, traffic speed, and/or other aspects that can affect travel speed along the prediction segment. The imagery may be used to determine a validity/accuracy of other information (e.g., event data may indicate that a parade is currently underway, however, images from vehicles traveling along the parade route may not depict anything related to the parade, and thus the parade may have been cancelled and the event data is stale/wrong).

In an example, the feature data 230 comprises sensor data captured by sensors of vehicles. The sensor data may comprise data captured by a LIDAR sensor/device or any other type of sensor data. The sensor data may be collected, stored, and transmitted from the vehicles to the speed prediction component 204 over the network.

In an example, the feature data 230 comprises a traffic trace image. The traffic trace image may correspond to a space/time diagram. Within the space/time diagram, distance along a segment (e.g., the prediction segment 232 or a segment within the spatial context 238 for the prediction segment 232) is represented by a first axis (e.g., an x-axis). Within the space/time diagram, time is represented along a second axis (e.g., a y-axis). Locations of a vehicle traveling the segment over time are represented as data points plotted within the space/time diagram. A data point may represent a location of the vehicle along the segment at a particular point in time. In an example, the data points may represent a trajectory/trace of the vehicle along the segment over time. Under normal driving behavior, traces go from the bottom left of the image to the top right, therefore having a positive gradient. The smaller the gradient of the data points (the plotted trajectory), the faster the vehicle is going because the data points indicate that the vehicle traveled a longer distance over a shorter period of time than if the data points had a larger gradient. Similarly, the larger the gradient of the data points (the plotted trajectory), the slower the vehicle is going because the data points indicate that the vehicle traveled a shorter distance over a longer period of time than if the data points had a smaller gradient. Data points of multiple vehicles may be plotted within the space/time diagram, and thus trajectories of multiple vehicles are represented by the traffic trace image. The traffic trace image may be generated based upon the locational information collected from the vehicles traveling within the travel network 202. The traffic trace image may be processed by a particular type of model, such as a convolutional neural network that can process the traffic trace image to recognize traffic patterns, which can be used for speed predictions.

In this way, a variety of feature data 230 may be collected by the speed prediction component 204. The feature data 2320 may be preprocessed and used with the ground truth data 252 (e.g., speed of a segment at a particular time) as input into the model 254 for training the model 254 and machine learning functionality 256 of the model 254 for outputting speed predictions.

A particular model such as the model 254 or multiple models may be selected based upon various criteria for generating a speed prediction 258 for the prediction segment 232. For example, one or more models may be selected from a set of available models based upon a driving behavior exhibited for the prediction segment 232 and/or for an area surrounding the prediction segment 232 (e.g., driving behavior along one or more segments within the spatial context 238). That is, available models within the set of available models may be mapped to driving behaviors (e.g., drivers tend to follow the rules of the road such as speed limits very strictly; drivers tend to drive 10 miles per hour over posted speed limits; drivers tend to run red lights; drivers tend to do rolling stops at stop signs; etc.). Accordingly, the one or more models mapped to the driving behavior exhibited for the prediction segment 232 and/or the area surrounding the prediction segment 232 may be selected because the model may be tailored for that particular driving behavior (e.g., a model may comprise parameters that are tuned to take into account the fact that drivers tend to drive 10 miles per hour over posted speed limits when predicting travel speeds).

In another example, the one or more models may be selected based upon the type of the features that will be used to train the one or more models. For example, a certain type of model may be tailored to learn how patterns of one-dimensional convolutional features/parameters differ across space/distance along a segment, while another model may be tailored to learn how patterns of two-dimensional convolutional features/parameters differ across both space/distance along a segment and over time. A wide variety of models may be available, such as a convolutional neural network (CNN) tailored to process fixed graphs such as images (e.g., a traffic trace image), a graph convolutional neural network (GCNN) tailored to process arbitrary graph structures (e.g., a graph structure corresponding to a subgraph of the travel network 202 that represents segments within the spatial context 238 and the prediction segment 232), etc.

At 104, features of the feature data 230 for the spatial context 238 and the prediction segment 232 are formatted into a format compatible for input into the model 254. The features may be formatted based upon a structure of the model 254, such as being formatted for a fixed graph structure, formatted for an arbitrary graph structure, etc. That is, the features may be formatted into a format that is expected by the model 254 for input of features (e.g., input expected by the machine learning functionality 256).

In an example of generating the ground truth data 252 to input into the model 254 for training the model 254 to output the speed prediction 258 for the prediction segment 232, the ground truth data 252 is generated to comprise data (e.g., speed data points of a segment at particular times) of the prediction segment 232 over a timespan and features of the segments within the spatial context 238 over the timespan (e.g., the past 30 minutes or any other timespan). For example, the ground truth data 252 may comprise an average speed of objects (e.g., vehicles, pedestrians, mobile devices, etc.) that traveled along the prediction segment 232 and/or segments within the spatial context 238 for the prediction segment 232 during the timespan. The ground truth data 252 may comprise a historic average speed for the prediction segment 232 and/or segments within the spatial context 238 for the prediction segment 232 during the timespan. The ground truth data 252 may comprise a weather condition within an area surrounding the prediction segment 232 and/or segments within the spatial context 238 for the prediction segment 232.

For each ground truth speed data point within the ground truth data 252, corresponding features may be created, such as a feature corresponding to incident information of incidents predicted to affect travel speed along the prediction segment 232 and/or segments within the spatial context 238 for the prediction segment 232. Another feature may comprise a traffic trace image for the prediction segment 232 and/or segments within the spatial context 238 for the prediction segment 232. Another feature may comprise vehicle operation data of vehicles that traveled the prediction segment 232 and/or segments within the spatial context 238 for the prediction segment 232. Another feature may comprise imagery captured by cameras associated with vehicles that traveled the prediction segment 232 and/or segments within the spatial context 238 for the prediction segment 232. Another feature may comprise event data of events having predicted likelihoods of influencing travel speed along the prediction segment 232 above a threshold.

Certain features of segments within the spatial context 238 and the prediction segment 232 may be selective included or excluded to use for the ground truth data 252. In an example, features of select segments within the spatial context 238 may be included to use with the ground truth data 252 based upon a gradient in travel speed amongst those segments being greater than a threshold. That is, change points within the feature data 230 may be detected. These change points may correspond to large gradients in segment speeds. Features of these segments are used with the ground truth data 252 to train the model 254 to accurately predict speeds in situations where traffic speeds are changing quickly, which can reduce latency from when a traffic speed quickly changes to when speed predictions will reflect the traffic speed changes. In an example, a portion of the ground truth data 252 is filtered (removed) based upon that portion of the ground truth data 252 being reported by a certain type of object, such as where data obtained from certain types of vehicles are excluded to be used with the ground truth data 252 (e.g., semi-trucks, delivery vehicles, cars, vehicles within an high-occupancy vehicle lane, runners vs walking pedestrians, etc.). For example, locational information from delivery vehicles that frequently stop may be filtered and not used with the ground truth data 252.

In an example, outlier features may be identified and removed from the ground truth data 252. For example, time series data of locational information for a segment across a period of time may be aggregated to create aggregated statistics, such as median segment speed within a rolling 15 minute window. The aggregated statistics can be used to identify outlier data/features to exclude from the ground truth data 252. In another example, if there is less than a threshold number of speed values for a segment within the spatial context 238, then additional speed values may be imputed for inclusion within the spatial context 238 to use within the ground truth data 252 until there is the threshold number of speed values for the segment. Thus, additional data may be imputed for situations where there is spare data.

At 106, the formatted features and the ground truth data 252, may be input into the model 254 for generating the speed prediction 258 for the prediction segment 232. In particular, the machine learning functionality 256 of the model 254 may be trained on the ground truth data 252 and the formatted features to calculate and output the speed prediction 258. In an example of training the model 254, certain segments may have a single lane, while other segments may have multiple lanes. If a segment has multiple lanes, then certain lanes may have different traffic speed characteristics than other lanes (e.g., a passing lane may have faster travel speeds than a non-passing lane). In this way, the model 254 may be trained with different features for different lanes so that the model 254 can learn how traffic speed can be lane dependent.

In an example of training the model 254, a first layer of the model 254 may be trained using one-dimensional convolutional features that differ along a segment. The one-dimensional convolutional features may be processed by the first layer of the model 254 to learn spatial patterns that can change along the segment. A second layer of the model 254 may be trained using two-dimensional convolutional features that differ along a segment. The two-dimensional convolutional features may be processed by the second layer of the model 254 to learn spatiotemporal patterns that can change along the segment. In this way, the model 254 may be trained based upon various features and the ground truth data 252 to output the speed prediction 258 for the prediction segment. The speed prediction 258 may be for a near-future time (e.g., a current travel speed prediction) or a future time (e.g., a travel speed prediction for 20 minutes in the future).

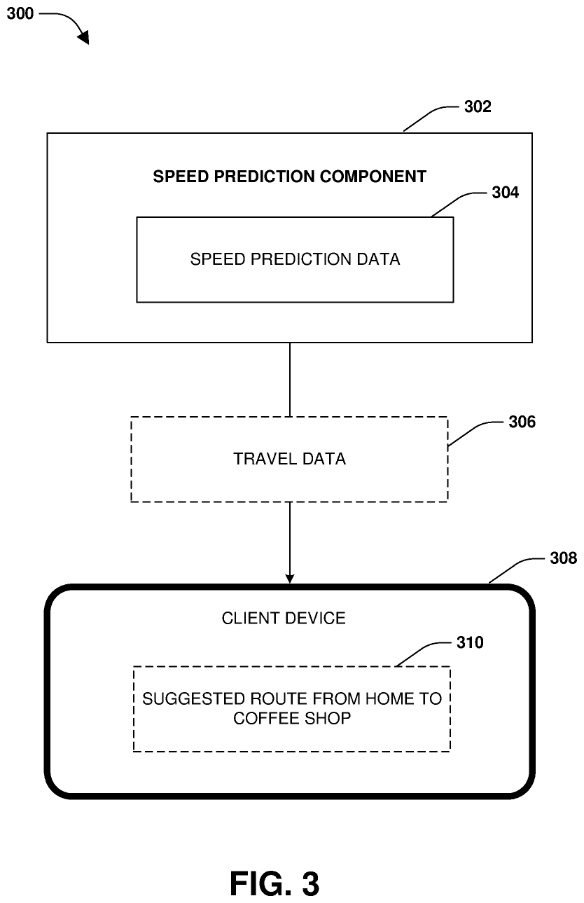

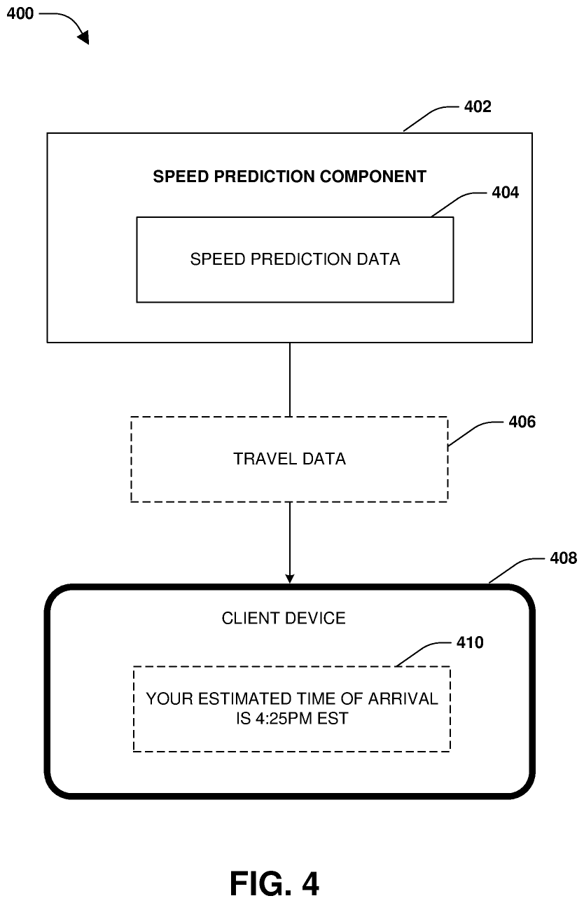

At 108, travel data, such as an estimated time of arrival and/or a route, may be generated based upon the speed prediction 258 and displayed on a display of a device, such as a mobile device, a vehicle computer, etc., which is further illustrated by the example system 300 of FIG. 3 and the example system 400 of FIG. 4. FIG. 3 illustrates an example of the system 300 where a speed prediction component 302 generates speed prediction data 304 using a model. The speed prediction data 304 may be used to generate travel data 306, such as a suggested route from a home location to a coffee shop based upon the speed prediction data 304 indicating that the suggested route will be a fastest route. The travel data 306 is transmitted by the speed prediction component 302 over a network to a client device 308 for display 310. FIG. 4 illustrates an example of the system 400 where a speed prediction component 402 generates speed prediction data 404 using a model. The speed prediction data 404 may be used to generate travel data 406, such as an estimated time of arrival to a destination location based upon the speed prediction data 404 being indicative of speeds that will be traveled by a vehicle or person. The travel data 406 is transmitted by the speed prediction component 402 over a network to a client device 408 for display 410.

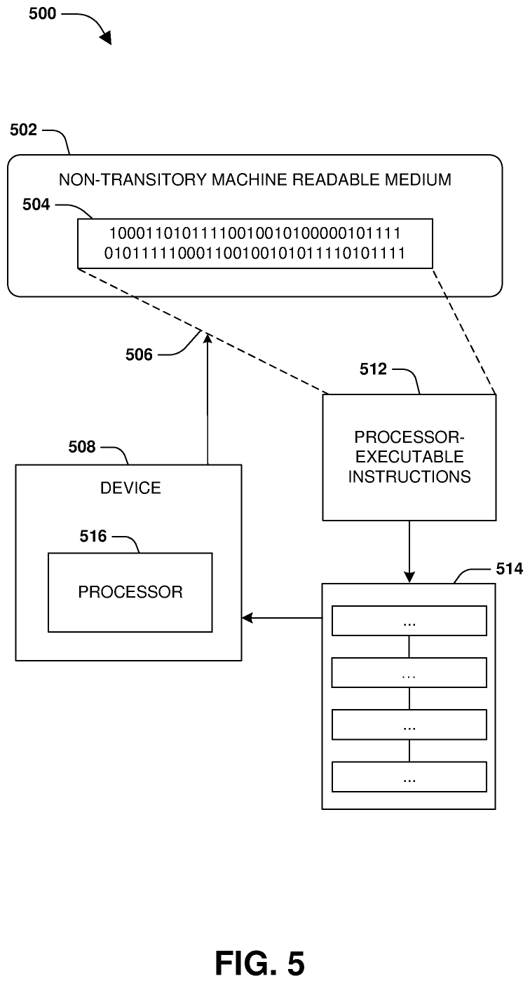

FIG. 5 is an illustration of a scenario 500 involving an example non-transitory machine readable medium 502. The non-transitory machine readable medium 502 may comprise processor-executable instructions 512 that when executed by a processor 516 cause performance (e.g., by the processor 516) of at least some of the provisions herein. The non-transitory machine readable medium 502 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 502 stores computer-readable data 504 that, when subjected to reading 506 by a device 508 (e.g., a read head of a hard disk drive, or a read operation invoked on a solid-state storage device), express the processor-executable instructions 512. In some embodiments, the processor-executable instructions 512, when executed cause performance of operations 514, such as at least some of the example method 100 of FIG. 1, for example. In some embodiments, the processor-executable instructions 512 are configured to cause implementation of a system, such as at least some of the example system 200 of FIG. 2A-2C, at least some of the example system 300 of FIG. 3, at least some of the example system 400 of FIG. 4, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

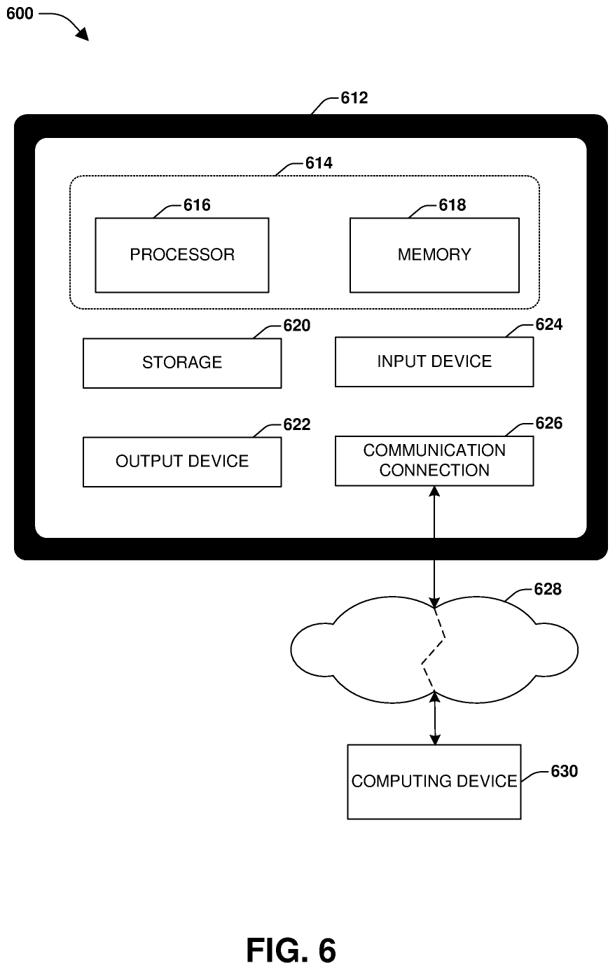

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processor 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processor 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection 626 that allows device 612 to communicate with other devices. Communication connection 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection 626 may include a wired connection or a wireless connection. Communication connection 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device 624 such as keyboard, mouse, pen, voice input device, touch input device, infrared cameras, video input devices, and/or any other input device. Output device 622 such as one or more displays, speakers, printers, and/or any other output device may also be included in device 612. Input device 624 and output device 622 may be connected to device 612 via a wired connection, wireless connection, or any combination thereof. In one embodiment, an input device or an output device from another computing device may be used as input device 624 or output device 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method involving a computing device comprising a processor, and the method comprising:
executing, on the processor, instructions that cause the computing device to perform operations, the operations comprising:
identifying a spatial context of a prediction segment of a travel network for which a speed prediction is to be made, wherein the spatial context comprises one or more segments of the travel network that are part of trajectories of objects passing through the prediction segment and having predicted likelihoods of influencing travel speed along the prediction segment above a threshold;
formatting features of the spatial context into a format compatible for input into a model based upon a structure of the model; and
inputting the features into the model for processing using machine learning functionality to output the speed prediction for the prediction segment.

2. The method of claim 1, comprising:
generating travel data based upon the speed prediction, wherein the travel data comprises at least one of a travel route or an estimated time of arrival; and
displaying the travel data on display of a device.

3. The method of claim 1, comprising:
generating ground truth data for the model as speed data points for at least one of the prediction segment or segments within the spatial context, wherein the ground truth data corresponds to a set of features for a segment within the spatial context during a timespan, wherein the set of features comprises at least one of an average speed of objects along the segment within the timespan, a historic average speed for the segment during the timespan, a weather condition within an area surrounding the segment, or incident information of incidents predicted to affect travel speed along the segment.

4. The method of claim 3, comprising:
identifying and removing outlier features from the ground truth data.

5. The method of claim 1, wherein the object comprises at least one of a vehicle, a bike, a scooter, a truck, or a mobile device, and wherein the travel network corresponds to at least one a road network of roads or a sidewalk network of sidewalks.

6. The method of claim 1, comprising:
utilizing the model to predict a future speed prediction for the prediction segment.

7. The method of claim 3, comprising:
identifying a set of segments and timespans of speed data points along the set of segments for inclusion within the ground truth data based upon an identification of a gradient in travel speed amongst the set of segments being greater than a threshold.

8. The method of claim 1, comprising:
training the model with event data of an event having a predicted likelihood of influencing the travel speed along the prediction segment above the threshold.

9. The method of claim 3, comprising:
filtering a first portion of the ground truth data to remove the first portion from the ground truth data based upon a vehicle type of a vehicle from which the first portion of the ground truth data was collected.

10. A computing device comprising:
a processor; and
memory comprising processor-executable instructions that when executed by the processor cause performance of operations, the operations comprising:
identifying a spatial context of a prediction segment of a travel network for which a speed prediction is to be made, wherein the spatial context comprises one or more segments of the travel network that are part of trajectories of objects passing through the prediction segment and having predicted likelihoods of influencing travel speed along the prediction segment above a threshold;
formatting features of the spatial context into a format compatible for input into a model based upon a structure of the model; and
inputting the features into the model for processing using machine learning functionality to output the speed prediction for the prediction segment.

11. The computing device of claim 10, the operations comprising:
training the model using at least one of vehicle operation data of a vehicle that traveled a segment within the spatial context, imagery captured by a camera associated with the vehicle, or sensor data captured by a sensor associated with the vehicle.

12. The computing device of claim 10, the operations comprising:
training the model using a traffic trace image corresponding to a space/time diagram where distance along a segment is represented along a first axis of the space/time diagram and time is represented along a second axis of the space/time diagram, wherein a convolutional neural network is utilized to process the traffic trace image to recognize traffic patterns for speed predictions.

13. The computing device of claim 10, the operations comprising:
training the model using one-dimensional convolutional features that differ along a segment, wherein the one-dimensional convolutional features are processed by a first layer of the model to learn spatial patterns; and
training the model using two-dimensional convolutional features that differ along the segment and across time, wherein the two-dimensional convolutional features are processed by a second layer of the model to learn spatial temporal patterns.

14. The computing device of claim 10, the operations comprising:
in response to determining that there is less than a threshold number of speed values for a segment within the spatial context, imputing additional speed values for inclusion within the spatial context until there is the threshold number of speed values for the segment within the spatial context.

15. A non-transitory machine readable medium having stored thereon processor-executable instructions that when executed cause performance of operations, the operations comprising:
identifying a spatial context of a prediction segment of a travel network for which a speed prediction is to be made, wherein the spatial context comprises one or more segments of the travel network that are part of trajectories of objects passing through the prediction segment and having predicted likelihoods of influencing travel speed along the prediction segment above a threshold;
formatting features of the spatial context into a format compatible for input into a model based upon a structure of the model; and
inputting the features into the model for processing using machine learning functionality to output the speed prediction for the prediction segment.

16. The non-transitory machine readable medium of claim 15, the operations comprising:
training the model based upon a first set of features for a first lane of a segment within the spatial context and a second set of features for a second lane of the segment.

17. The non-transitory machine readable medium of claim 15, the operations comprising:
selecting the model from a set of available models mapped to different driving behaviors based upon the model corresponding to a driving behavior exhibited for the prediction segment or area surrounding the prediction segment.

18. The non-transitory machine readable medium of claim 15, wherein a trajectory comprises an ordered list of segments through which a device traversed during a travel session.

19. The non-transitory machine readable medium of claim 15, wherein a segment is defined as a portion of the travel network that does not cross a junction.

20. The non-transitory machine readable medium of claim 15, wherein a segment is defined as a portion of the travel network that does not exceed a maximum length, and wherein a distribution of segment lengths is within a threshold uniformity.
